(19) United States
(12) Patent Application Publication
(10) Pub. No.: US 2014/0078369 A1
(43) Pub. Date: Mar. 20, 2014

(54) IMAGE SENSOR, IMAGING DEVICE, IMAGING METHOD AND INFORMATION PROCESSING APPARATUS

(71) Applicant: Sony Corporation, Tokyo (JP)

(72) Inventor: Ryuhei Morita, Kagoshima (JP)

(73) Assignee: SONY CORPORATION, Tokyo (JP)

(21) Appl. No.: 13/969,074

(22) Filed: Aug. 16, 2013

(30) Foreign Application Priority Data
Sep. 20, 2012 (JP) 2012-206836

(51) Int. Cl. H04N 5/372

(52) U.S. Cl. CPC H04N 5/372
USPC 348/311

(57) ABSTRACT

There is provided an image sensor including a plurality of sensors for autofocus. The sensors are divided into a plurality of groups. Clock signals for drive in different timings for each group are supplied to the sensors.

### BACKGROUND

The present technology relates to an image sensor, an imaging device, an imaging method and an information processing apparatus and specifically relates to an image sensor, an imaging device, an imaging method and an information processing apparatus of reducing power consumption in autofocusing and the like and a noise component.

Devices such as cameras and scanners employing a CCD (Charge Coupled Device) are prevailing. Their pixels are increasing for improvement of capturing accuracy and attainment of high image quality, this causing increasing power consumption. Thus, it is desired to reduce the power consumption, Japanese Patent Laid-Open No. 2003-202952 proposes reduction of power consumption by suspending H registers of chips that are not in use as to a contact sensor.

### SUMMARY

A chip built in a CCD linear sensor for autofocus also tends to include an increase number of built-in pixels for improvement of autofocus accuracy and operate at an increasing frequency for readout in order to reduce readout time. Moreover, such increase of the number of pixels built in the chip leads to an increasing area for CCD shift registers. The area for CCD shift registers is almost proportional to the capacity of CCD shift register parts. The current consumption caused by charging/discharging in the CCD shift register parts is proportional to the following expression:

(capacity of CCD shift register parts)×(readout operation frequency).

The capacity of the CCD shift register parts and the readout operation frequency are both increasing, this causing increase of the power consumption in the CCD shift register parts. Accordingly, the chip built in the CCD linear sensor for autofocus is also desired to operate in a power saving manner.

It is desirable to reduce power consumption in a sensor such as a CCD.

According to an embodiment of the present technology, there is provided an image sensor including a plurality of sensors for autofocus. The sensors are divided into a plurality of groups. Clock signals for drive in different timings for each group are supplied to the sensors.

Normal drive and power saving drive may be used. The clock signals for the drive in different timings for each group may be supplied to sensors other than the sensors set to the normal drive.

Drive timings of the clock signals may be shifted to a plurality of timings in a manner that the sensors belonging to different groups are not driven in an identical timing.

The clock signals may be set in a manner that a rising edge timing and a falling edge timing of the clock signals supplied to the different groups are not an identical timing.

The sensors may be CCDs.

The sensors may be configured not to be driven in outputting data other than data for the autofocus.

According to an embodiment of the present technology, there is provided an imaging device including a plurality of sensors for autofocus. The sensors are divided into a plurality of groups. Clock signals for drive in different timings for each group are supplied to the sensors.

According to an embodiment of the present technology, there is provided an imaging method including providing a plurality of sensors for autofocus, dividing the sensors into a plurality of groups, and supplying clock signals for drive in different timings for each group to the sensors.

According to an embodiment of the present technology, there is provided an imaging device including a plurality of chips. The chips are chips performing processing in relation to imaging and divided into a plurality of groups. Clock signals for drive in different timings for each chip are supplied to the chips.

According to an embodiment of the present technology, there is provided an information processing apparatus including a plurality of circuits. The circuits are divided into a plurality of groups. Clock signals for drive in different timings for each circuit are supplied to the circuits.

According to an embodiment of the present technology, there is provided an image sensor wherein a plurality of sensors for autofocus are divided into a plurality of groups and clock signals are supplied for drive in different timings for the individual groups.

According to an embodiment of the present technology, there are provided first imaging device and imaging method wherein a plurality of sensors for autofocus are divided into a plurality of groups and clock signals are supplied for drive in different timings for the individual groups.

According to an embodiment of the present technology, there is provided a second imaging device wherein a plurality of chips which are chips performing processing in relation to imaging are divided into a plurality of groups and clock signals are supplied for drive in different timings for the individual chips.

According to an embodiment of the present technology, there is provided an information processing apparatus wherein a plurality of circuits are divided into a plurality of groups and clock signals are supplied for drive in different timings for the individual circuits.

According to an embodiment of the present technology, power consumption in a sensor such as a CCD can be reduced.

### BRIEF DESCRIPTION OF THE DRAWINGS

FIG. 1 is a diagram for explaining a configuration of a CCD linear sensor;

FIG. 2 a diagram for explaining arrangement of sensors;

FIG. 3 is a diagram for explaining range finding points;

FIG. 4 is a diagram for explaining another type of arrangement of sensors;

FIG. 5 is a diagram for explaining a configuration of a sensor chip;

FIGS. 6A and 6B are diagrams for explaining clock signals;

FIG. 7 a diagram for explaining grouping of sensor pairs;

FIG. 8 is a diagram for explaining clock signals;

FIGS. 9A to 9D are diagrams for explaining clock signals;

FIG. 10 is a diagram for explaining another type of grouping of sensor pairs;

FIGS. 11A and 11B are diagrams for explaining clock signals;

FIG. 12 is a diagram for explaining clock signals;

FIG. 13 is a diagram for explaining a configuration of a CIS module; and

FIG. 14 a diagram for explaining a recording medium.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted. Incidentally, the description is made in the following order.

1. Configuration of CCD Linear Sensor

2. Range Finding Points

3. Range Finding Sensor Pairs

4. Transfer Clock Signals

5. Grouping of Range Finding Sensor Pairs

6. Readout in 1/2 Cycle

7. Recording Medium

[Configuration of CCD Linear Sensor]

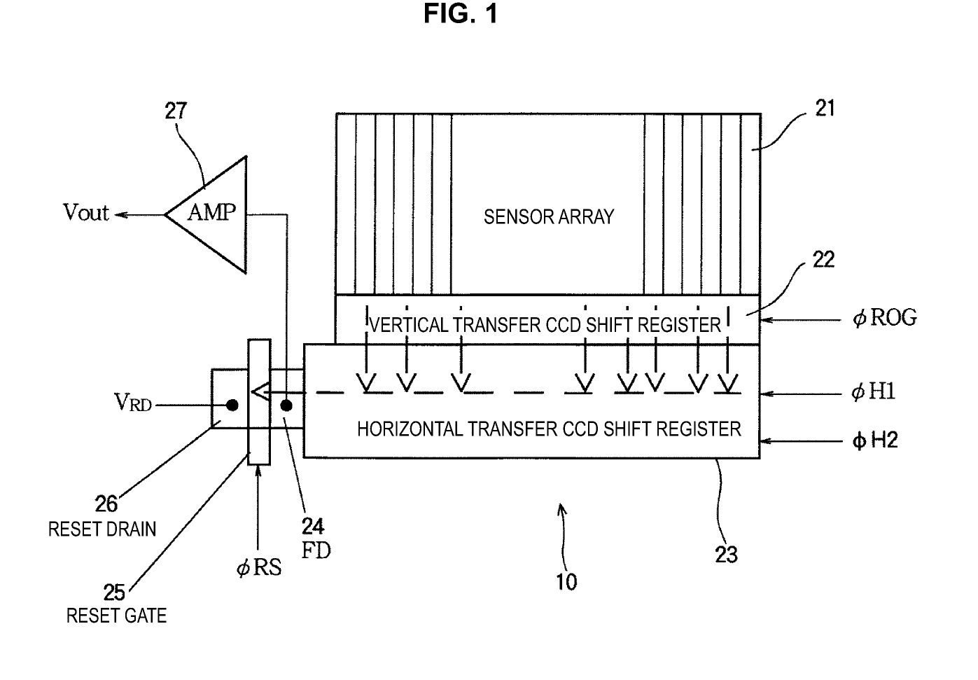

FIG. 1 is a diagram illustrating a configuration according to an embodiment of a CCD linear sensor to which the present technology is applied. A CCD linear sensor 10 illustrated in FIG. 1 includes a sensor array 21, a vertical transfer CCD shift register 22, a horizontal transfer CCD shift register 23, a FD (Floating Diffusion) 24, a reset gate 25, a reset drain 26 and an amplification transistor (AMP: amplifier) 27.

The sensor array 21 is configured of unit pixels each of which has a photoelectric transducer, for example, a photodiode generating photocharge with a charge amount according to an amount of incident light to accumulate inside and which pixels are arranged into a matrix shape. Among sensors included in the sensor array 21, each set of sensors which are arranged in the vertical direction is independently connected to the vertical transfer CCD shift register 22.

The vertical transfer CCD shift register 22 includes a plurality of registers and can independently hold charges accumulated in the sensors connected to each register. Moreover, the vertical transfer CCD shift register 22 is connected to the horizontal transfer CCD shift register 23 and can shift the held charges stage-by-stage to supply to the horizontal transfer CCD shift register 23 sequentially. The charges transferred to the FD 24 by the processing of the horizontal transfer CCD shift register 23 are amplified by the amplification transistor 27, and after that, supplied to a not-shown processing part downstream.

Incidentally, a shift register such as the vertical transfer CCD shift register 22 and the horizontal transfer CCD shift register 23 suffers from charge that leads to a noise component under the influence of heat and the like. Such charge that leads to a noise component should be removed. In the CCD linear sensor 10 illustrated in FIG. 1, the removal of charge leading to a noise component includes driving the shift registers, once accumulating the charge in the FD 24 and discharging it to the reset drain 26 in drive timing of the reset gate 25. Such flow of the unwanted charge is indicated by the dotted lines in FIG. 1.

As above, there is a possibility of unwanted charge arising and the unwanted charge thus arising should be discharged as one process. Such discharge of the unwanted charge should be performed periodically (at a predetermined interval). Meanwhile, it is proposed that drive signals for sensor arrays not in use are suspended to be supplied in order to reduce power consumption. The unwanted charge, however, arises even in suspending the supply of the drive signals. Hence, upon starting (resuming) the supply of the drive signals, the unwanted charge is to be outputted also in addition to signal charge.

Accordingly, the unwanted charge is preferable to be discharged periodically even during the sensors being not in use in order that the unwanted charge is not outputted in addition to signal charge. Such periodical discharge of the unwanted charge allows the influence of unwanted charge to be minimized.

As described below, according to the embodiment of the present technology, control for discharging unwanted charge periodically can be performed and power consumption for the control can be reduced.

[Range Finding Points]

According to the embodiment of the present technology, power consumption can be reduced, and as one example of such a CCD linear sensor capable of reducing its power consumption, it is exemplified by a CCD linear sensor for autofocus (AF). Herein, it is exemplified by a CCD one, whereas it may also be configured by a CMOS (Complementary Metal Oxide Semiconductor) sensor or the like.

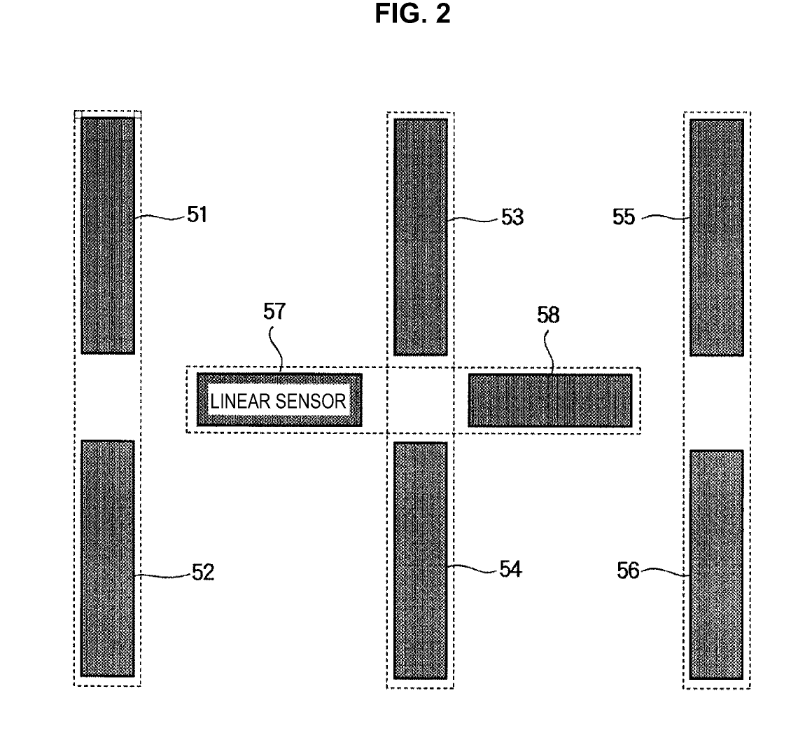

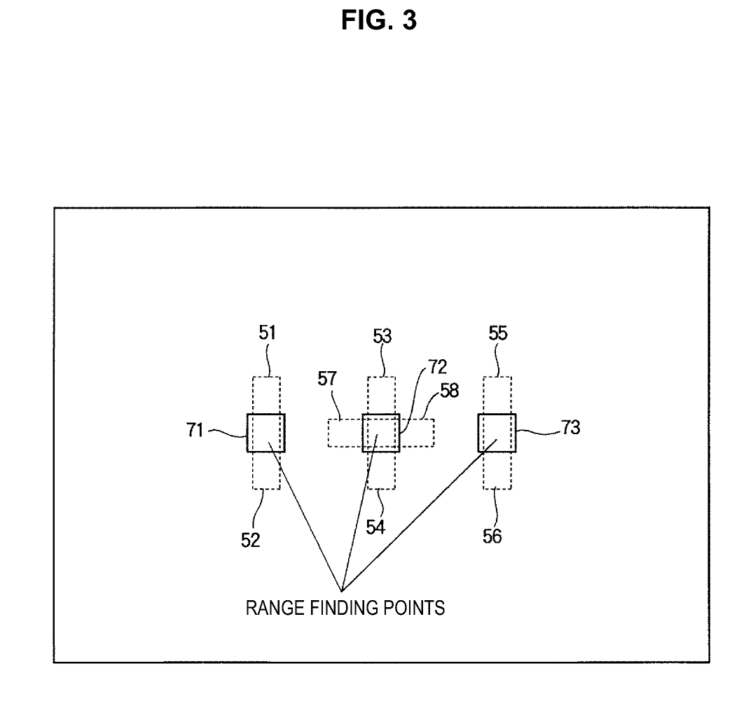

A chip which CCD linear sensors for autofocus are built in receives light incident from an optical system including lenses and the like and outputs the received light as an electric signal according to the amount of the light. The CCD linear sensors for autofocus are, for example, arranged as illustrated in FIG. 2. One range finding point as illustrated in FIG. 3 is detected. The arrangement of the CCD linear sensors illustrated in FIG. 2 is an arrangement example of range finding sensor pairs included in three range finding points illustrated in FIG. 3. In the example illustrated in FIG. 3, three range finding points 71 to 73 are present provided in an image capturing screen. One pair or a plurality of pairs of range finding sensors are provided at the position corresponding to each of the range finding points 71 to 73. Each range finding sensor is the CCD linear sensor.

A CCD linear sensor array is configured by arranging a plurality of sensors. Hereafter, the CCD linear sensor array is also represented as a linear sensor array. A linear sensor array 51 and a linear sensor array 52 are disposed around the range finding point 71. Similarly, a linear sensor array 55 and a linear sensor array 56 are disposed around the range finding point 73.

Around the range finding point 72, a linear sensor array 53 and a linear sensor array 54 are disposed similarly to the above, and in addition, a linear sensor array 57 and a linear sensor array 58 are also disposed. The range finding point 72 is also referred to as a cross range finding point or the like, and around it, two pairs of linear sensor arrays (range finding sensors) are disposed such that they are perpendicular to each other. Moreover, around each of the other range finding points, a pair of range finding sensors is disposed. The range finding point 72 can attain more measurement accuracy of range finding than the other points because the range finding is performed using the two sets of linear sensor arrays arranged in the vertical and horizontal directions.

Detecting displacement between two images in an arrangement direction of such a pair of linear sensor arrays (separating direction) enables range finding operation. Hereafter, linear sensor arrays included in one range finding point is represented as a range finding sensor pair. Moreover, as illustrated in FIG. 2, linear sensor arrays included in a range finding sensor pair are enclosed by a broken-lined rectangle which indicates that they are a range finding sensor pair. The same applies to the other figures.

[Range Finding Sensor Pairs]

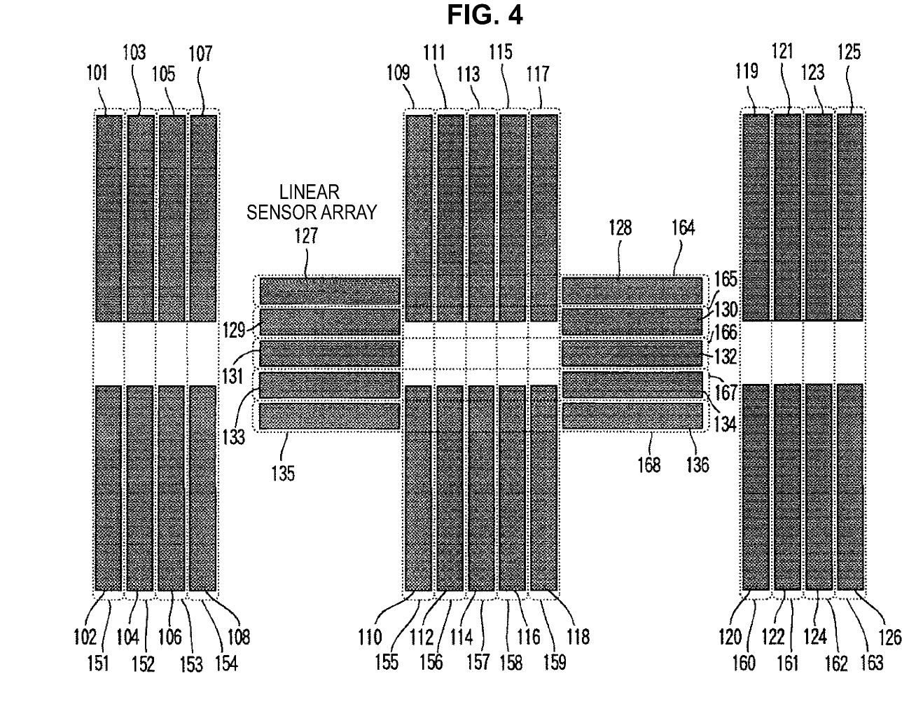

The example illustrated in FIG. 2 and FIG. 3 is an example of four range finding sensor pairs, whereas the number of range finding sensor pairs is not limited to four. FIG. 4 illustrates an example of eighteen range finding sensor pairs.

In the example illustrated in FIG. 4, a linear sensor array 101 and a linear sensor array 102 are included in a range finding sensor pair 151. Similarly, a linear sensor array 103 and a linear sensor array 104 are included in a range finding sensor pair 152, a linear sensor array 105 and a linear sensor array 106 are included in a range finding sensor pair 153, and a linear sensor array 107 and a linear sensor array 108 are included in a range finding sensor pair 154. These range finding sensor pairs include sets of the linear sensor arrays each set of which is arranged in the vertical direction in the left portion of the figure.

In the center portion of the figure, sets of a linear sensor array 109 and a linear sensor array 110, a linear sensor array 111 and a linear sensor array 112, a linear sensor array 113 and a linear sensor array 114, a linear sensor array 115 and a linear sensor array 116, and a linear sensor array 117 and a linear sensor array 118 each set of which is arranged in the vertical direction are included in range finding sensor pairs 155 to 159, respectively.

In the right portion of the figure, sets of a linear sensor array 119 and a linear sensor array 120, a linear sensor array 121 and a linear sensor array 122, a linear sensor array 123 and a linear sensor array 124, and a linear sensor array 125 and a linear sensor array 126 each set of which is arranged in the vertical direction are included in range finding sensor pairs 160 to 163, respectively.

In the center portion of the figure, sets of a linear sensor array 127 and a linear sensor array 128, a linear sensor array 129 and a linear sensor array 130, a linear sensor array 131 and a linear sensor array 132, a linear sensor array 133 and a linear sensor array 134, and a linear sensor array 135 and a linear sensor array 136 each set of which is arranged in the horizontal direction are included in range finding sensor pairs 164 to 168, respectively.

The range finding sensor pairs arranged like this are, for example, built in a CCD linear sensor chip for autofocus (AF). Moreover, outputs from the individual range finding sensor pairs are integrated into one line and the linear sensor arrays are switched for output. When the number of range finding sensor pairs built in is large, they are integrated into several lines such as two lines and the linear sensor arrays which are to be readout from the same line are switched for output. Hereafter, the description continues for the eighteen range finding sensor pairs illustrated in FIG. 4 which are integrated into one line through which the range finding sensor pairs are switched for output.

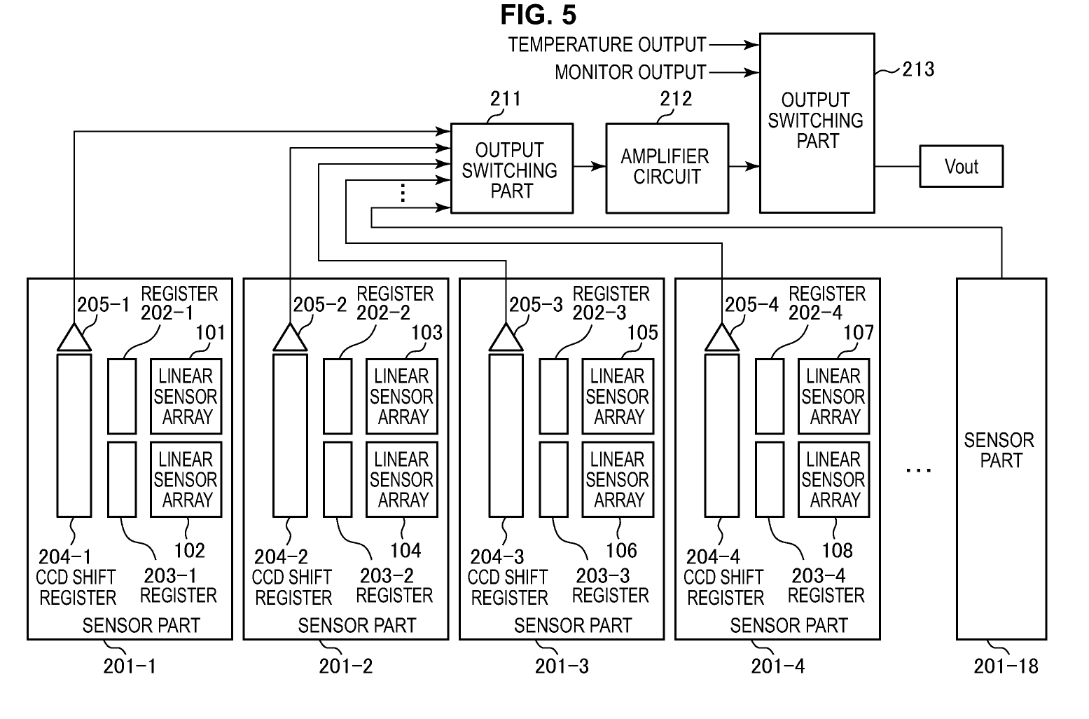

FIG. 5 is a functional block diagram of the CCD linear sensor chip for AF. Sensor parts 201-1 to 201-18, an output switching part 211, an amplifier circuit 212 and an output switching part 213 are built in the CCD linear sensor chip for AF. Since the sensor parts 201-1 to 201-18 have the same configuration, they are exemplified by the sensor part 201-1. In addition, when the sensor parts 201-1 to 201-18 do not have to be discriminated individually, each of them is represented simply as a sensor part 201 in the following description. Moreover, this representation applies to other portions similarly.

The sensor part 201-1 includes a linear sensor array 101, a linear sensor array 102, a register 202-1, a register 203-1, a CCD shift register 204-1 and an amplification part 205-1. One sensor part 201 can have a configuration including the configuration of the CCD linear sensor 10 illustrated in FIG. 1.

The linear sensor array 101 and linear sensor array 102 are linear sensor arrays arranged in the vertical direction as illustrated in FIG. 4, and are linear sensor arrays included in a range finding sensor pair. One sensor part 201 includes one range finding sensor pair. Each of the linear sensor array 101 and linear sensor array 102 corresponds to the sensor arrays 21 in FIG. 1.

Charge from the linear sensor array 101 in the sensor part 201-1 is once accumulated in the register 202-1 and transferred to the CCD shift register 204-1 in predetermined timing. Similarly, charge from the linear sensor array 102 in the sensor part 201-2 is once accumulated in the register 203-1 and transferred to the CCD shift register 204-1 in predetermined timing.

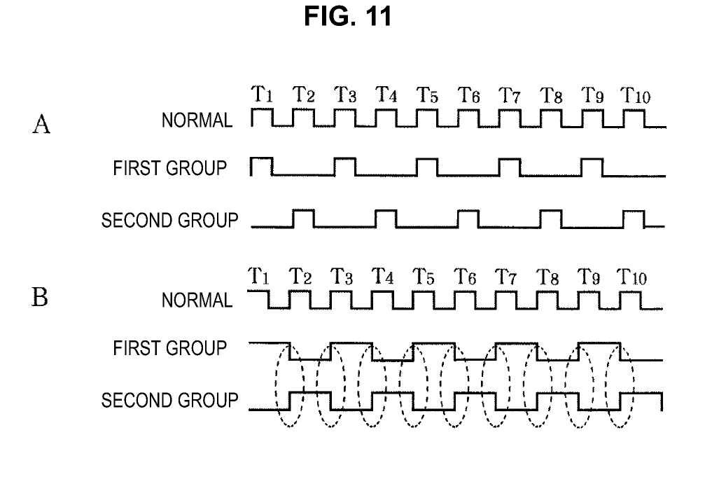

The register 202-1 and register 203-1 correspond, for example, to the vertical transfer CCD shift register 22 in FIG. 11. Moreover, the CCD shift register 204-1 corresponds, for example, to the horizontal transfer CCD shift register 23 in FIG. 1.

The charge accumulated in the CCD shift register 204-1 is transferred to the amplification part 205-1 in predetermined timing, amplified therein and supplied to the output switching part 211. To the output switching part 211, signals outputted from the sensor parts 201-2 to 201-18 are also supplied. The output switching part 211 selects one signal out of the signals from the sensor parts 201-1 to 201-18 according to a selection signal from a not-shown control part to supply to the amplifier circuit 212.

The amplifier circuit 212 amplifies the supplied signal to output to the output switching part 213. To the output switching part 213, a signal regarding temperature (temperature output in FIG. 5) and a signal such as monitor output are also supplied from other sensors. The output switching part 213 selects one out of the supplied signals according to a selection signal from the not-shown control part to output to a not-shown processing part downstream.

[Transfer Clock Signals]

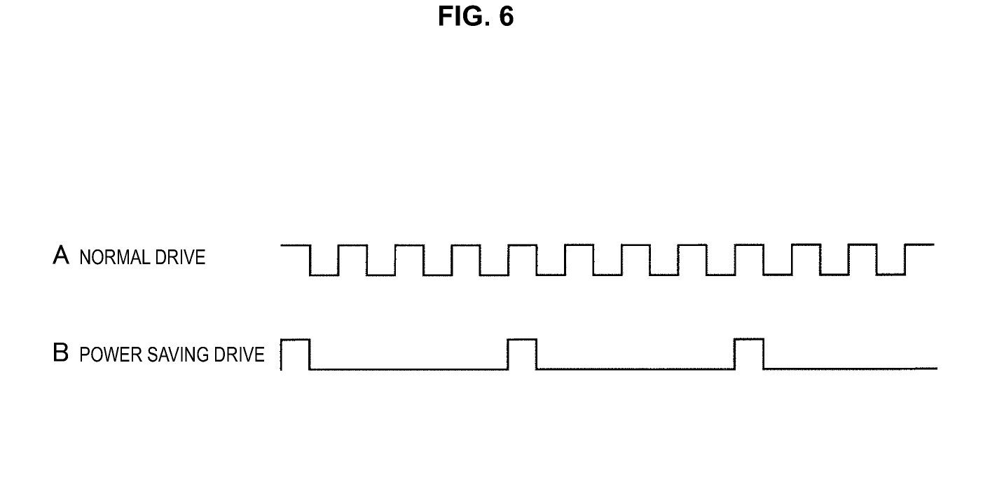

The description has been made that the sensor part 201 outputs a signal to the output switching part 211 in predetermined timing. This predetermined timing is described additionally. To the CCD shift register 204 in the sensor part 201, a CCD transfer clock signal having a waveform illustrated in FIG. 6A is supplied. When the signal that is illustrated in FIG. 6A is 1 (High), a signal is transferred from the CCD shift register 204 to the output switching part 211 via the amplification part 205.

The CCD transfer clock signal illustrated in FIG. 6A is referred to as a clock signal in normal drive. Even when this CCD transfer clock signal in normal drive is supplied, an output of any one sensor part 201 of the sensor parts 201-1 to 201-18 is selected and outputted from the output switching part 211. In this case, a linear sensor array for readout and linear sensor arrays not for readout are present.

In order to suppress power consumption, it can be considered that the CCD transfer clock signal to the linear sensor arrays not for readout is suspended. Suspending the CCD transfer clock signal enables power consumed during the suspension to be 0, suppressing the power consumption.

Suspending the CCD transfer clock signal, however, results in accumulation of unwanted charge in the CCD shift register 204, causing noise to arise. Therefore, in order to suppress noise from arising, discharge operation of the unwanted charge should be performed at a time point before the readout operation. An extra period by this discharge operation of the unwanted charge is expected, possibly causing fast readout to be prevented.

Hence, it can be considered that power saving drive is attained using a CCD transfer clock signal with a waveform as illustrated in FIG. 6B. The CCD transfer clock signal illustrated in FIG. 6B indicates a waveform at a low frequency for the clock signal. Using the CCD transfer clock signal at such a low frequency enables the current consumption to be suppressed. For example, when the transfer clock signal not for readout is made 1/2 or 1/4 in frequency, the current consumption can be made 1/2 or 1/4.

Making the transfer clock signal not for readout low in frequency, that is, 1/2 or 1/4, however, causes 2 times or 4 times the unwanted charge to arise relative to that in normal drive. Due to this, there is a possibility that the influence is larger than in normal drive caused by the noise. Nevertheless, since the charge arising during the suspension of the transfer clock signal is smaller than the charge arising in CCD transfer operation, it can be considered that the influence of the charge arising during the suspension of the transfer clock signals is small. Therefore, the discharge operation of the unwanted charge does not have to be performed at a time point before the readout operation.

When the power saving drive using the CCD transfer clock signal as illustrated in FIG. 6B is performed, there is a possibility of designing in which current consumption is suppressed and in which discharge operation of unwanted charge does not have to be performed. However, driving the CCD shift registers 204 not for readout in the identical timing at a 1/2 or 1/4 frequency relative to that in the pixel readout leads to a possibility that fixed pattern noise in a 2-pixel cycle or 4-pixel cycle arises caused by charge/discharge current of the CCD shift registers 204 flowing in the power supply and GND at this frequency.

Hence, a CCD linear sensor chip for AF will be described capable of suppressing current consumption in power saving drive, making discharge operation of unwanted charge unnecessary and preventing fixed pattern noise.

[Grouping of Distance Measurement Sensor Pairs]

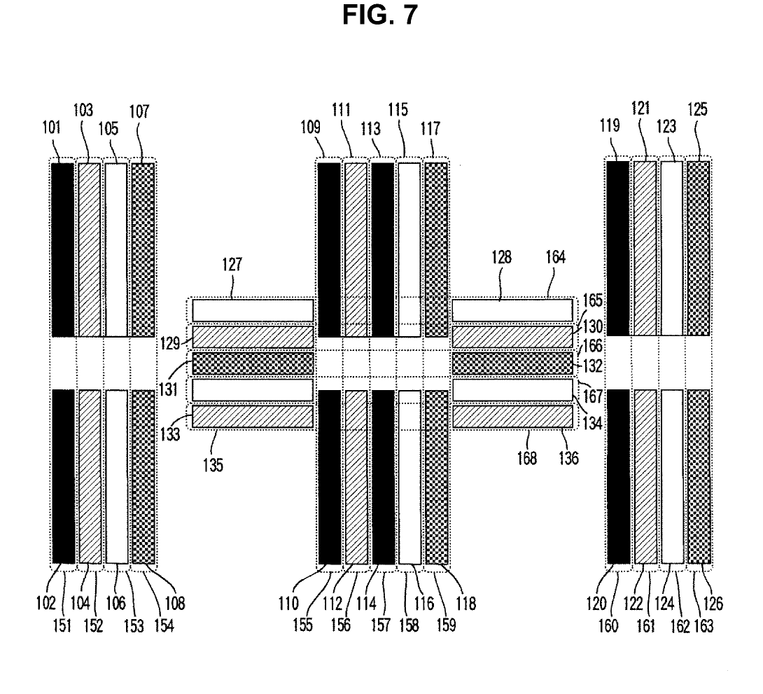

FIG. 7 illustrates a case of range finding sensor pairs divided into four groups, being same as the arrangement example of the range finding sensor pairs illustrated in FIG. 4. In FIG. 7, range finding sensor pairs belonging to the first group are represented by being filled with black, range finding sensor pairs belonging to the second group are represented by being filled with diagonal lines, range finding sensor pairs belonging to the third group are represented by being filled with white and range finding sensor pairs belonging to the fourth group are represented by being filled with dots.

The range finding sensor pairs belonging to the first group are a range finding sensor pair 151, a range finding sensor pair 155, a range finding sensor pair 157 and a range finding sensor pair 160. The range finding sensor pairs belonging to the second group are a range finding sensor pair 152, a range finding sensor pair 156, a range finding sensor pair 161, a range finding sensor pair 165 and a range finding sensor pair 168.

The range finding sensor pairs belonging to the third group are a range finding sensor pair 153, a range finding sensor pair 158, a range finding sensor pair 162, a range finding sensor pair 164 and a range finding sensor pair 167. The range finding sensor pairs belonging to the fourth group are a range finding sensor pair 154, a range finding sensor pair 159, a range finding sensor pair 163 and a range finding sensor pair 166.

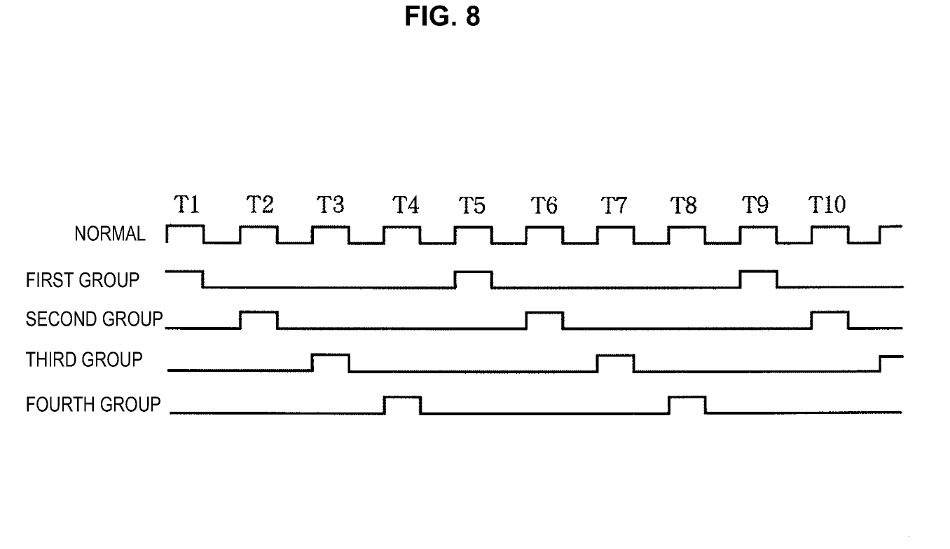

As above, the range finding sensor pairs are divided into the four groups and the CCD shift registers 204 of the sensor arrays not for readout are driven in timings which are shifted in phase and illustrated in FIG. 8 for the individual groups. Namely, the clock signal for normal drive is supplied to the sensor arrays for readout, and the sensor arrays except the sensor arrays for readout are set to power saving drive and, to the sensor arrays that are set to power saving drive, the clock signals corresponding to the respective groups to which these sensors belong are supplied.

The waveform presented in the top portion of FIG. 8 is a waveform of the CCD transfer clock signal in normal drive, and is same as the waveform illustrated in FIG. 6A. The waveforms presented in the second, third, fourth and fifth portions from the top of FIG. 8 are waveforms of the CCD transfer clock signals which are supplied to the range finding sensor pairs that are set to power saving drive, respectively.

The waveform presented in the second portion from the top of FIG. 8 is a waveform of the CCD transfer clock signal supplied to the range finding sensor pairs belonging to the first group. The waveform presented in the third portion from the top of FIG. 8 is a waveform of the CCD transfer clock signal supplied to the range finding sensor pairs belonging to the second group. The waveform presented in the fourth portion from the top of FIG. 8 is a waveform of the CCD transfer clock signal supplied to the range finding sensor pairs belonging to the third group. The waveform presented in the fifth portion from the top of FIG. 8 is a waveform of the CCD transfer clock signal supplied to the range finding sensor pairs belonging to the fourth group.

For example, the range finding sensor pair 155 being set to the readout sensor array is described as an example. The range finding sensor pair 155 is a range finding sensor pair belonging to the first group. In such a case, the clock signal in normal drive illustrated in FIG. 8 is supplied to the range finding sensor pair 155 which is set to the normal drive based on the clock signal thus supplied.

To the range finding sensor pairs belonging to the first group except the range finding sensor pair 151, for example, the range finding sensor pair 151 and the range finding sensor pair 157, the clock signal in power saving drive presented in the second portion from the top of FIG. 8, that is, the clock signal to the range finding sensor pairs belonging to the first group is supplied. Those pairs except the range finding sensor pair 151 are set to the power saving drive based on the clock signal thus supplied.

The clock signal in power saving drive presented in the third portion from the top of FIG. 8, that is, the clock signal to the range finding sensor pairs belonging to the second group is supplied to the range finding sensor pairs belonging to the second group which are set to the power saving drive based on the clock signal thus supplied.

The clock signal in power saving drive presented in the fourth portion from the top of FIG. 8, that is, the clock signal to the range finding sensor pairs belonging to the second group is supplied to the range finding sensor pairs belonging to the third group which are set to the power saving drive based on the clock signal thus supplied.

The clock signal in power saving drive presented in the fifth portion from the top of FIG. 8, that is, the clock signal to the range finding sensor pairs belonging to the second group is supplied to the range finding sensor pairs belonging to the fourth group which are set to the power saving drive based on the clock signal thus supplied.

The range finding sensor pairs of the first group that are set to the power saving drive undergo the readout in timing T1 and timing T5. Moreover, the range finding sensor pairs of the second group that are set to the power saving drive undergo the readout in timing T2 and timing 16.

Moreover, the range finding sensor pairs of the third group that are set to the power saving drive undergo the readout in timing 13 and timing 17. Moreover, the range finding sensor pairs of the fourth group that are set to the power saving drive undergo the readout in timing T4 and timing T8.

For example, to the CCD shift register 204-1 of the sensor part 201-1 (FIG. 5) including the range finding sensor pair 151 belonging to the first group that is set to the power saving drive, the CCD transfer clock signal having the waveform presented in the second portion from the top of FIG. 8 is supplied. Accordingly, the readout is performed from the CCD shift register 204-1 in timing T1 and timing T5.

Moreover, for example, to the CCD shift register 204-2 of the sensor part 201-2 (FIG. 5) including the range finding sensor pair 152 belonging to the second group that is set to the power saving drive, the CCD transfer clock signal having the waveform presented in the third portion from the top of FIG. 8 is supplied. Accordingly, the readout is performed from the CCD shift register 204-2 in timing T2 and timing T6.

Moreover, for example, to the CCD shift register 204-3 of the sensor part 201-3 (FIG. 5) including the range finding sensor pair 153 belonging to the third group that is set to the power saving drive, the CCD transfer clock signal having the waveform presented in the fourth portion from the top of FIG. 8 is supplied. Accordingly, the readout is performed from the CCD shift register 204-3 in timing T3 and timing T7.

Moreover, for example, to the CCD shift register 204-4 of the sensor part 201-4 (FIG. 5) including the range finding sensor pair 154 belonging to the fourth group that is set to the power saving drive, the CCD transfer clock signal having the waveform presented in the fifth portion from the top of FIG. 8 is supplied. Accordingly, the readout is performed from the CCD shift register 204-4 in timing T4 and timing T8.

Focusing on one group, the CCD shift register 204 that are set to the power saving drive is driven in a 1/4 cycle. Therefore, in this case, the current consumption can be reduced down to 1/4 relative to that in the normal drive.

As described in reference to FIG. 6B, current consumption can be reduced in power saving drive. Moreover, although making the transfer clock signals not for readout low in frequency, that is, 1/4 causes 4 times the unwanted charge to arise relative to that in normal drive, the charge arising during the suspension of the transfer clock signals is smaller than the charge arising in CCD transfer operation. Therefore, the influence of the charge arising during the suspension of the transfer clock signals is small. Hence, a configuration can be attained in which current consumption is reduced, and in addition, a discharge period of the unwanted charge is excluded.

However, the description in reference to FIG. 6B contains a risk that fixed pattern noise in a 4-pixel cycle arises in the output part, caused by charge/discharge current of the CCD shift registers 204 flowing in the power supply and GND at a frequency, when the CCD shift registers 204 not for readout are driven in the identical timing at the frequency which is 1/4 relative to that in the pixel readout.

Driving the CCD shift registers 204 not for readout at frequencies which are 1/4 relative to that in the pixel readout as illustrated in FIG. 8 in contrast to FIG. 6B can prevent fixed pattern noise in a 4-pixel cycle caused by charge/discharge current of the CCD shift registers 204 flowing in the power supply and GND at this frequency from arising since timings of the readout are different for the individual groups.

Moreover, since charge/discharge current of the CCD shift registers 204 is made 1/4, output coupling noise can be reduced and EMI (Electromagnetic Interference; electromagnetic noise) can be suppressed. The operation can be performed in combination with an SSCG (Spread Spectrum Clock Generator; clock generator with frequency modulation functions), this also enabling EMI to be suppressed as necessary.

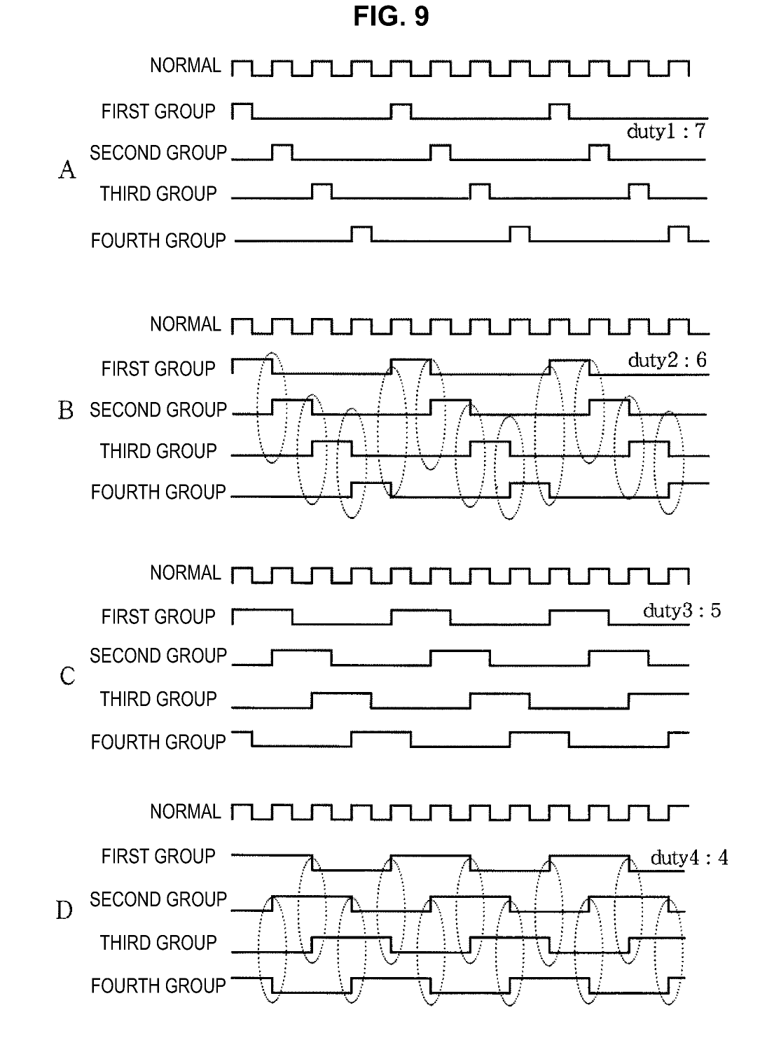

When the range finding sensor pairs are divided into the four groups and the CCD shift register 204 of the sensor array for readout is driven in timing which is shifted in phase for each group, a duty ratio is preferable to be considered. FIGS. 9A to 9D illustrate waveforms in different duty ratios. Similarly to FIG. 8, the waveforms in each of FIGS. 9A to 9D are a waveform of a readout signal in normal drive as the topmost waveform, a waveform of a readout signal to the range finding sensor pairs belonging to the first group as the second waveform from the top, a waveform of a readout signal to the range finding sensor pairs belonging to the second group as the third waveform from the top, a waveform of a readout signal to the range finding sensor pairs belonging to the third group as the fourth waveform from the top and a waveform of a readout signal to the range finding sensor pairs belonging to the fourth group as the fifth waveform from the top.

The waveforms illustrated in FIG. 9A are the waveforms illustrated in FIG. 8 and have a duty ratio of 1:7. In case of the waveforms illustrated in FIG. 9A, since a rising edge timing and a falling edge timing of the signals supplied to the individual groups are not the identical timing, fixed pattern noise can be prevented from arising. Moreover, in the case of the waveforms illustrated in FIG. 9A, noise arising at once can be reduced down to approximately ¼ at most.

The waveforms illustrated in FIG. 9B are waveforms whose readout period is 2 times longer than that of the waveforms illustrated in FIG. 9A. The waveforms illustrated in FIG. 9B have a duty ratio of 2:6. In the waveforms illustrated in FIG. 9B, there are portions in each of which a rising edge timing and a falling edge timing of the signals supplied to the individual groups are the identical timing. Such portions of the identical timing are indicated by dotted-lined circles. In such a case, although noise arising at once can be reduced down to approximately 1/2 at most, fixed pattern noise at an interval of 2 cycles of the clock signal in normal drive can arise.

The waveforms illustrated in FIG. 9C are waveforms whose readout period is 3 times longer than that of the waveforms illustrated in FIG. 9A. The waveforms illustrated in FIG. 9C have a duty ratio of 3:5. In case of the waveforms illustrated in FIG. 9C, since a rising edge timing and a falling edge timing of the signals supplied to the individual groups are not the identical timing, fixed pattern noise can be prevented from arising. Moreover, in the case of the waveforms illustrated in FIG. 9C, noise arising at once can be reduced down to approximately 1/4 at most.

The waveforms illustrated in FIG. 9D are waveforms whose readout period is 4 times longer than that of the waveforms illustrated in FIG. 9A. The waveforms illustrated in FIG. 9D have a duty ratio of 4:4. In the waveforms illustrated in FIG. 9D, there are portions in each of which a rising edge timing and a falling edge timing of the signals supplied to the individual groups are the identical timing. Such portions of the identical timing are indicated by dotted-lined circles. In such a case, although noise arising at once can be reduced down to approximately 1/2 at most, fixed pattern noise at an interval of 2 cycles of the clock signal in normal drive can arise.

As above, range finding sensor pairs are divided into groups and clock signals in different readout timings are supplied for the individual groups, and in such a case, the clock signals should be set in consideration of a duty ratio. In case of no consideration regarding a duty ratio, since load current varies for each drive timing, fixed pattern noise can appear therein. In conclusion, the clock signals illustrated in FIG. 9A or FIG. 9C in a duty ratio of 1:7 or 3:5 is a preferable clock signal leading to no chance of fixed pattern noise appearing.

As above, according to the embodiment, a plurality of sensors for autofocus are divided into a plurality of groups, and clock signals for drive in different timings for the individual groups are supplied to the sensors. Moreover, normal drive and power saving drive are used, and the clock signals for the drive in different timings for the individual groups are supplied to the sensors except the sensor set to the normal drive, this enabling to prevent unwanted charge from being accumulated and to reduce power consumption.

Moreover, in consideration of a duty ratio and the like, the clock signals supplied to the sensors that are set to the power saving drive are clock signals whose drive timings are shifted to a plurality of timings such that the sensors belonging to the different groups are not driven in the identical timing. Moreover, the clock signals are set such that a rising edge timing and a falling edge timing of the clock signals supplied to the different groups are not the identical timing, this enabling to prevent fixed pattern noise from arising.

In the above-mentioned example, driving the CCD shift registers 204 of the sensor arrays not for readout in a 1/4 cycle has been described as an example, whereas there is no limitation to such a 1/4 frequency when applying the present technology. For example, as described below, the present technology can be applied also to a case of driving the CCD shift registers 204 of the sensor arrays not for readout in a 1/2 cycle.

[Readout in 1/2 Cycle]

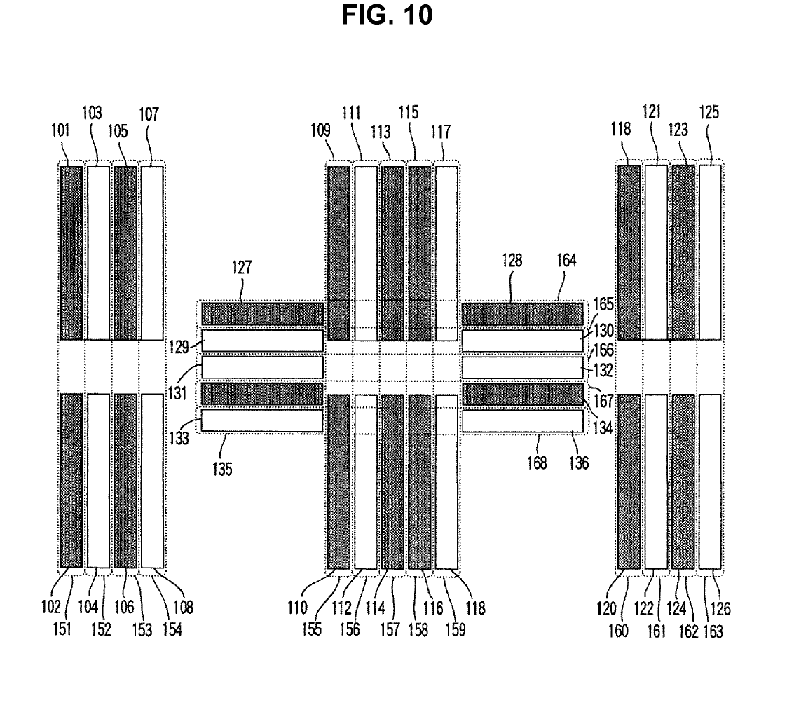

FIG. 10 illustrates a case of range finding sensor pairs divided into two groups, being same as the arrangement examples of the range finding sensor pairs illustrated in FIG. 4 and FIG. 7. In FIG. 10, range finding sensor pairs belonging to the first group are represented by being filled with black and range finding sensor pairs belonging to the second group are represented by being filled with white.

The range finding sensor pairs belonging to the first group are a range finding sensor pair 151, a range finding sensor pair 153, a range finding sensor pair 155, a range finding sensor pair 157, a range finding sensor pair 158, a range finding sensor pair 160, a range finding sensor pair 162, a range finding sensor pair 164 and a range finding sensor pair 167.

The range finding sensor pairs belonging to the second group are a range finding sensor pair 152, a range finding sensor pair 154, a range finding sensor pair 156, a range finding sensor pair 159, a range finding sensor pair 161, a range finding sensor pair 163, a range finding sensor pair 165, a range finding sensor pair 166 and a range finding sensor pair 168.

As above, the range finding sensor pairs are divided into the two groups and the CCD shift registers 204 of the sensor arrays for readout are driven in timings which are shifted in phase and illustrated in FIGS. 11A and 11B for the individual groups to which the range finding sensor pairs set to power saving drive belong. The waveforms illustrated in the respective topmost portions of FIG. 11A and FIG. 11B are waveforms of the CCD transfer clock signals in normal drive, being same as the waveform illustrated in FIG. 6A.

The waveforms presented in the second portions from the tops of FIGS. 11A and 11B are waveforms of the CCD transfer clock signals supplied to the range finding sensor pairs belonging to the first group that are set to power saving drive. The waveforms presented in the third portions from the tops of FIGS. 11A and 11B are waveforms of the CCD transfer clock signals supplied to the range finding sensor pair belonging to the second group that are set to power saving drive.

When the readout is performed using readout clock signals based on FIG. 11A, the readout is performed from the range finding sensor pairs that are set to the power saving drive for the first group in timing T1, timing T3, timing T5, timing T7 and timing T9. Meanwhile, the readout is performed from the range finding sensor pairs that are set to the power saving drive for the second group in timing 12, timing T4, timing T6, timing T8 and timing T10.

For example, when the range finding sensor pair 151 belonging to the first group is set to the power saving drive, to the CCD shift register 204-1 of the sensor part 201-1 (FIG. 5) including the range finding sensor pair 151, the CCD transfer clock signal having the waveform presented in the second portion from the top of FIG. 11A is supplied. Accordingly, the readout is performed from the CCD shift register 204-1 in timing T1, timing T3, timing T5, timing T7 and timing T9.

Moreover, for example, when the range finding sensor pair 152 belonging to the second group is set to the power saving drive, to the CCD shift register 204-2 of the sensor part 201-2 (FIG. 5) including the range finding sensor pair 152, the CCD transfer clock signal having the waveform presented in the third portion from the top of FIG. 11A is supplied. Accordingly, the readout is performed from the CCD shift register 204-2 in timing T2, timing T4, timing T6, timing T8 and timing T10.

The waveforms illustrated in FIG. 11A have a duty ratio of 1:3. In case of the waveforms illustrated in FIG. 11A, since a rising edge timing and a falling edge timing of the signals individually supplied to the first group and the second group are not the identical timing, fixed pattern noise can be prevented from arising. Moreover, in the case of the waveforms illustrated in FIG. 11A, noise arising at once can be reduced down to approximately 1/2 at most.

The waveforms illustrated in FIG. 11B are waveforms whose readout period is 2 times longer than that of the waveforms illustrated in FIG. 11A. The waveforms illustrated in FIG. 11B have a duty ratio of 2:2. In case of the waveforms illustrated in FIG. 11B, there are portions in each of which a rising edge timing and a falling edge timing of the signals supplied to the individual groups are the identical timing. Such portions of the identical timing are indicated by dotted-lined circles. In such a case, noise arising at once is difficult to be reduced, and in addition, fixed pattern noise at an interval of 2 cycles of the clock signal in normal drive can arise. Accordingly, the clock signals like this are not suitable.

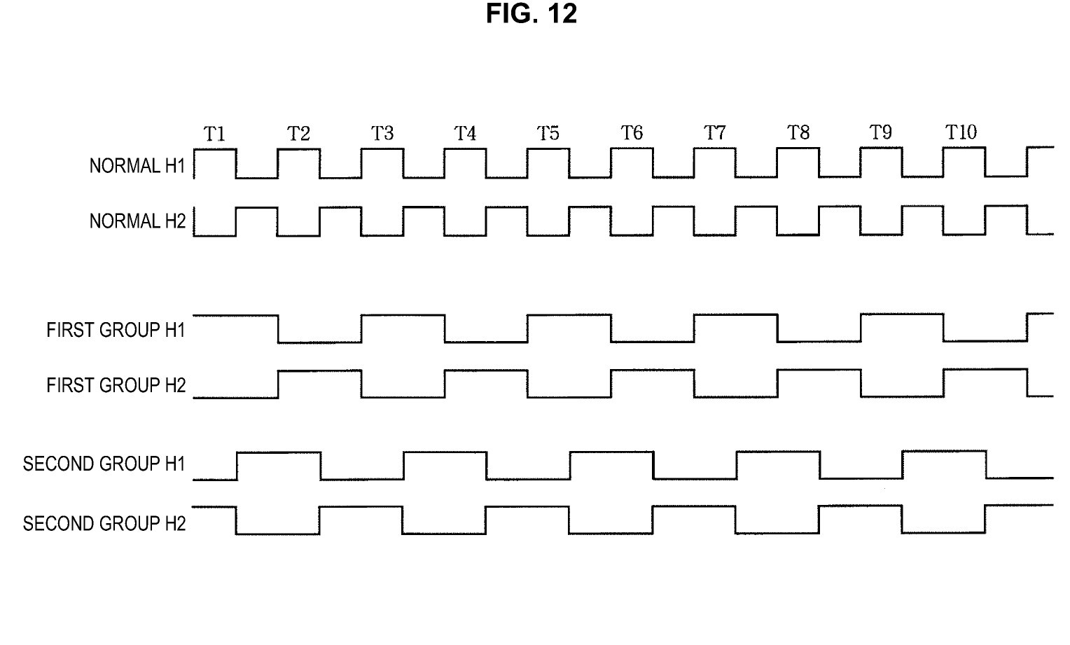

Nevertheless, when horizontal transfer clock signals for two-phase drive or the like are used which have a clock signal normally accompanied by its reverse phase counterpart as illustrated in FIG. 12, even in case of a duty ratio of 2:2 noise can be made 1/2. The two-phase drive referring to FIG. 12 supplies two dock signals named normal H1 and normal H2, which have a clock signal accompanied by its reverse phase counterpart to the range finding sensor pair in normal drive.

In power saving drive, two clock signals of a first group H1 and a first group H2 are supplied to the range finding sensor pairs of the first group. The clock signals of the first group H1 and the first group H2 are clock signals reverse in phase to each other.

Similarly, in power saving drive, two clock signals of a second group H1 and a second group H2 are supplied to the range finding sensor pairs of the second group. The clock signals of the second group H1 and the second group H2 are clock signals reverse in phase to each other.

As to relationship between a phase of the clock signals supplied to the range finding sensor pairs of the first group and a phase of the clock signal supplied to the range finding sensor pairs of the second group, they are shifted relative to each other as illustrated in FIG. 12. Namely, for example, the rising edge of the clock signal as the first group H1 is set so as not to appear in the identical timing with the falling edge of the clock signal as the second group H1. Using such clock signals enables to reduce noise caused by unwanted charge and to reduce current consumption without fixed pattern noise arising.

In addition, when clock signals for two-phase drive or the like are used which are normally reverse in phase to each other as illustrated in FIG. 12 and used in power saving drive, clock signals are used such that falling edge and rising edge timings of the clock signals supplied to the groups different from each other are not the identical timing. This applies to other than a 1/2 cycle and, for example, also applies to a cycle such as a 1/4 cycle. Moreover, in a cycle other than the 1/2 cycle, noise caused by unwanted charge can be reduced and current consumption can be reduced without fixed pattern noise arising.

As above, also in case of the range finding sensor pairs divided into two groups, supplying clock signals in consideration of a duty ratio enables to reduce noise caused by unwanted charge and to reduce current consumption without fixed pattern noise arising.

As above, according to the embodiment of the present technology, when a plurality of CCD linear sensors are on the identical chip and part of the sensors perform output, CCD register signal input to the rest of the sensors is made low in rate, their drive timings are shifted to a plurality of timings, and load capacities for the individual drive timings are made as uniform as possible. This enables to suppress current consumption and peak current. Moreover, low EMI can be attained. Moreover, a device can be realized in which a discharge period of unwanted charge for CCD is unnecessary.

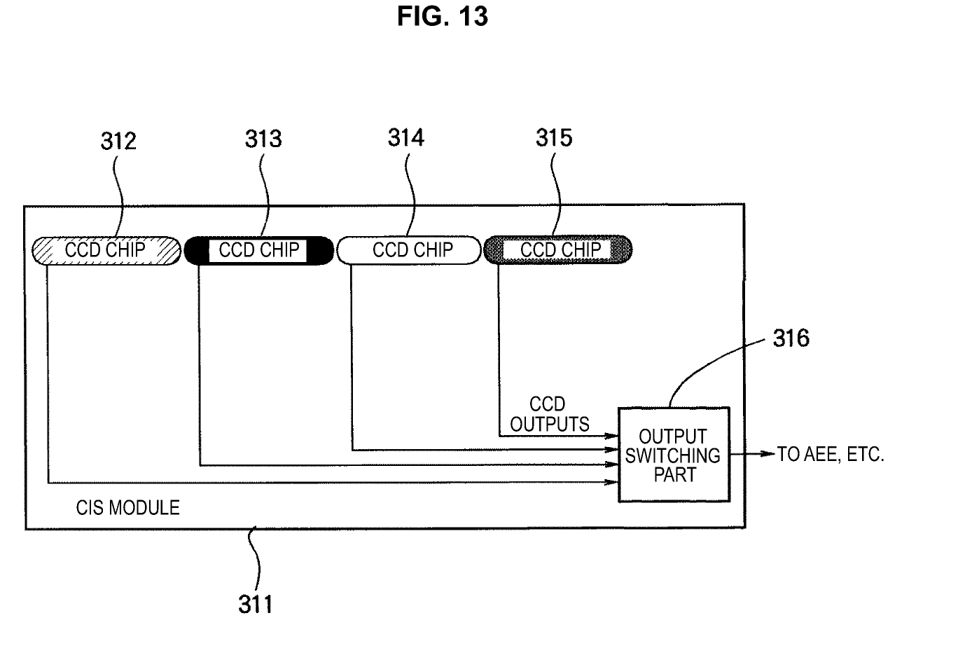

The present technology is not limited to application to chips but can also be applied to modules and devices. For example, the present technology can be applied to a module as illustrated in FIG. 13.

FIG. 13 is a diagram illustrating an exemplary configuration in which the present technology is applied to a CIS (Contact Image Sensor). The CIS is a contact module sensor used for a scanner or the like. A CIS module 311 includes CCD chips 312 to 315 and an output switching part 316 switching outputs from the CCD chips 312 to 315 and outputting one of the CCD outputs to a processing part downstream such as an AFT (Analog FrontEnd).

As to the above-mentioned AF sensor for CCD, control is performed sensor array-by-sensor array in the chip. As to the CIS module 311 illustrated in FIG. 13, phases of input clock signals are shifted for the individual CCD chips 312 to 315 built in the CIS module 311. The CIS module 311 illustrated in FIG. 13 includes the four CCD chips 312 to 315, this being same as in the range finding sensor pairs divided into four groups. Thus, for example, readout is controlled based on the clock signals illustrated in FIG. 8.

For example, the clock signal presented in the second portion from the top of FIG. 8 and supplied to the first group is supplied to the CCD chip 312, the clock signal presented in the third portion from the top of FIG. 8 and supplied to the second group is supplied to the CCD chip 313, the clock signal presented in the fourth portion from the top of FIG. 8 and supplied to the third group is supplied to the CCD chip 314 and the clock signal presented in the fifth portion of from the top FIG. 8 and supplied to the fourth group is supplied to the CCD chip 315.

The output switching part 316 only has to function as the output switching part 211 in FIG. 5 similarly. It selectively outputs any of the outputs from the CCD chips 312 to 315 to the processing part downstream. The CIS module 311 illustrated in FIG. 13 can also suppress current and attain low EMI.

As above, when a plurality of CCD chips are on the identical module and only part of the CCD chips perform output, signal input to the rest of the CCD chips is made low in rate, their drive timings are shifted to a plurality of timings, and loads for the individual timings are made as uniform as possible. This enables to suppress current consumption and peak current. Moreover, low EMI can be attained. Moreover, a device can be realized in which a discharge period of unwanted charge for CCD in the CCD chips is unnecessary.

Moreover, the present technology can be applied also to a case of a plurality of circuits on the identical device. When a plurality of circuits are on the identical device, only part of the circuits operate, the rest of the circuits can be set to a standby mode, input clock signals thereto are hardly suspended but operate slowly for stabilizing the operation of the circuits in the standby mode, clock signal timings of the rest of the circuits during the standby are shifted to a plurality of timings, and loads of the circuits driven in the individual timings are made as uniform as possible. This enables to suppress current consumption and peak current and to attain low EMI.

Moreover, rising edge and falling edge timings of input/output clock signals for a plurality of circuits in the identical device are set such that loads of operations at the rising edges and falling edges are dispersed to be made as uniform as possible for all the driving. This enables to suppress peak current and to attain low EMI.

Referring to FIG. 5 again, the output switching part 213 selects any of the output for AF from the amplifier circuit 212 and the outputs from the temperature and the monitor to output to the processing part downstream. When the output switching part 213 selects the temperature output or the monitor output for outputting, in other words, when any AF output is not outputted, all the sensor parts 201 may be set in power saving drive.

For example, as to the clock signals supplied to the sensor parts 201, for example, as to the clock signals illustrated in FIGS. 6A and 6B and the like, a period corresponding to a period during which any AF output is outputted may be provided in the clock signals as a period during which all the sensor parts 201 do not undergo the readout, this allowing all the sensor parts 201 to be in power saving drive. This enables further to reduce power consumption.

### [Recording Medium]

The series of processes described above can be executed by hardware but can also be executed by software. When the series of processes is executed by software, a program that constructs such software is installed into a computer. Here, the expression “computer” includes a computer in which dedicated hardware is incorporated and a general-purpose personal computer or the like that is capable of executing various functions when various programs are installed.

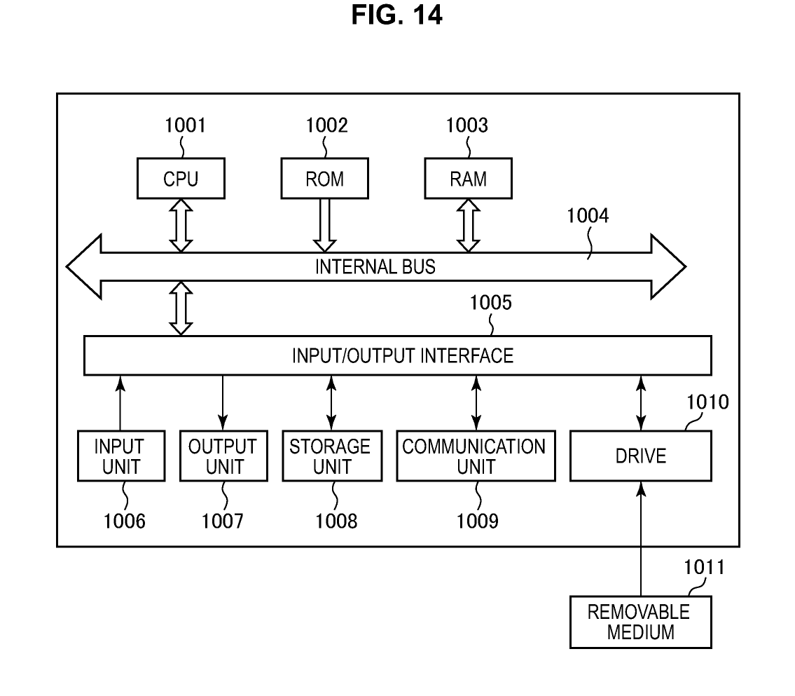

FIG. 14 is a block diagram illustrating an exemplary configuration of hardware of a computer executing a series of the above-mentioned processes according to a program. The computer includes a CPU (Central Processing Unit) 1001, a ROM (Read Only Memory) 1002 and a RAM (Random Access Memory) 1003, these connected to one another via a bus 1004. To the bus 1004, an I/O interface 1005 is further connected. The I/O interface 1005, an input unit 1006, an output unit 1007, a storage unit 1008, a communication unit 1009 and a drive unit 1010 are connected.

The input unit 1006 is configured from a keyboard, a mouse, a microphone or the like. The output unit 1007 is configured from a display, a speaker or the like. The storage unit 1008 is configured from a hard disk, a non-volatile memory or the like. The communication unit 1009 is configured from a network interface or the like. The drive 1010 drives a removable medium 1011 such as a magnetic disk, an optical disk, a magneto-optical disk, a semiconductor memory or the like.

In the computer configured as described above, as one example the CPU 1001 loads a program stored in the storage unit 1008 via the input/output interface 1005 and the bus 1004 into the RAM 1003 and executes the program to carry out the series of processes described earlier.

Programs to be executed by the computer (the CPU 1001) are provided being recorded in the removable medium 1011 which is a packaged medium or the like. Also, programs may be provided via a wired or wireless transmission medium, such as a local area network, the Internet or digital satellite broadcasting.

Regarding the computer, by inserting the removable medium 1011 into the drive 1010, the program can be installed in the storage unit 1008 via the input/output interface 1005. Further, the program can be received by the communication unit 1009 via a wired or wireless transmission medium and installed in the storage unit 1008. Moreover, the program can be installed in advance in the ROM 1002 or the storage unit 1008.

It should be noted that the program executed by a computer may be a program that is processed in time series according to the sequence described in this specification or a program that is processed in parallel or at necessary timing such as upon calling.

Further, in this specification, “system” refers to a whole device including a plurality of devices.

The embodiment of the present technology is not limited to the above-described embodiment. It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An image sensor including:

a plurality of sensors for autofocus,

wherein the sensors are divided into a plurality of groups, and

wherein clock signals for drive in different timings for each group are supplied to the sensors.

(2) The image sensor according to (1),

wherein normal drive and power saving drive are used, and

wherein the clock signals for the drive in different timings for each group are supplied to sensors other than the sensors set to the normal drive.

(3) The image sensor according to (1) or (2),

wherein drive timings of the clock signals are shifted to a plurality of timings in a manner that the sensors belonging to different groups are not driven in an identical timing.

(4) The image sensor according to any one of (1) to (3),

wherein the clock signals are set in a manner that a rising edge timing and a falling edge timing of the clock signals supplied to the different groups are not an identical timing.

(5) The image sensor according to any one of (1) to (4),

wherein the sensors are CCDs,

(6) The image sensor according to any one of (1) to (5),

wherein the sensors are not driven in outputting data other than data for the autofocus.

(7) An imaging device including:

a plurality of sensors for autofocus,

wherein the sensors are divided into a plurality of groups, and

wherein clock signals for drive in different timings for each group are supplied to the sensors.

(8) An imaging method including:

providing a plurality of sensors for autofocus;

dividing the sensors into a plurality of groups; and

supplying clock signals for drive in different timings for each group to the sensors.

(9) An imaging device including:

a plurality of chips,

wherein the chips are chips performing processing in relation to imaging and divided into a plurality of groups, and

wherein clock signals for drive in different timings for each chip are supplied to the chips.

(10) An information processing apparatus including:

a plurality of circuits,

wherein the circuits are divided into a plurality of groups, and

wherein clock signals for drive in different timings for each circuit are supplied to the circuits.

The present disclosure contains subject matter related to that disclosed in Japanese Priority Patent Application JP 2012-206836 filed in the Japan Patent Office on Sep. 20, 2012, the entire content of which is hereby incorporated by reference.

What is claimed is:

1. An image sensor comprising:
a plurality of sensors for autofocus,
wherein the sensors are divided into a plurality of groups, and
wherein clock signals for drive in different timings for each group are supplied to the sensors.

2. The image sensor according to claim 1,
wherein normal drive and power saving drive are used, and
wherein the clock signals for the drive in different timings for each group are supplied to sensors other than the sensors set to the normal drive.

3. The image sensor according to claim 1,
wherein drive timings of the clock signals are shifted to a plurality of timings in a manner that the sensors belonging to different groups are not driven in an identical timing.

4. The image sensor according to claim 1,
wherein the clock signals are set in a manner that a rising edge timing and a falling edge timing of the clock signals supplied to the different groups are not an identical timing.

5. The image sensor according to claim 1,
wherein the sensors are CCDs.

6. The image sensor according to claim 1,
wherein the sensors are not driven in outputting data other than data for the autofocus.

7. An imaging device comprising:
a plurality of sensors for autofocus,
wherein the sensors are divided into a plurality of groups, and
wherein clock signals for drive in different timings for each group are supplied to the sensors.

8. An imaging method comprising:
providing a plurality of sensors for autofocus;
dividing the sensors into a plurality of groups; and
supplying clock signals for drive in different timings for each group to the sensors.

9. An imaging device comprising:
a plurality of chips,
wherein the chips are chips performing processing in relation to imaging and divided into a plurality of groups, and
wherein clock signals for drive in different timings for each chip are supplied to the chips.

10. An information processing apparatus comprising:
a plurality of circuits,
wherein the circuits are divided into a plurality of groups, and
wherein clock signals for drive in different timings for each circuit are supplied to the circuits.
